(19) United States
(12) Patent Application Publication
(10) Pub. No.: US 2026/0014743 A1
(43) Pub. Date: Jan. 15, 2026

(54) METHOD FOR PRODUCING A HOLLOW MOLDED PART AND HOLLOW MOLDED PART OBTAINED THEREFROM

(71) Applicant: BASF SE, Ludwigshafen am Rhein (DE)

(72) Inventors: Ya Qin ZHANG, Shanghai (CN); Jing JIN, Shanghai (CN); Yuan FANG, Shanghai (CN); Heng Liang CHENG, Singapore (SG); Tapan CHANDRA, Shanghai (CN)

(21) Appl. No.: 18/994,698

(22) PCT Filed: Jul. 11, 2023
(86) PCT No.: PCT/EP2023/069100

§ 371 Date: Jan. 15, 2025

(30) Foreign Application Priority Data
Jul. 20, 2022 (WO) PCT/CN2022/106691

(51) Int. Cl. B29C 45/17; A41D 19/04; B29C 45/00; B29K 77/00; B29L 31/00

(52) U.S. Cl. CPC B29C 45/1711; A41D 19/04; B29C 45/0001; B29K 2077/10; B29L 2031/757

(57) ABSTRACT

The present invention concerns a method for injection moulding an ultra-thin walled article such as a glove (1), having in the thickness range 0.01 mm to 2.50 mm. The method entails injecting plasticised material into a mould and then stripping the moulded article from the mould, it being a feature of the invention that the valve gates adjacent to the surface of the mould are opened and closed independently of the injection stroke of the main injection barrel such that maximum or near maximum injection pressures may be built up within the plasticised material in the runner system before the valve gates are opened to allow material to flow into the mold cavity. In this respect, the present invention enables techniques associated with injection moulding, such as for example the production of engineered surface finishes or of localised variations in thickness, to be applied to thin-walled articles.

### TECHNICAL FIELD

The present invention relates to a method for producing a hollow molded part, and a hollow molded part obtained by the method.

### BACKGROUND

Dipping former is a part used to shape dipping products such as rubber gloves by dip molding. In dip molding, the dipping former is dipped into a polymer emulsion, the polymer particles in the emulsion coalesce on the dipping former and form a polymer film, and then the former is taken out of the emulsion with a uniform deposit leaving on the former. If desired, the thickness of the deposit can be increased by repeated dipping. After the dipping product is formed, it can be leached, vulcanized and dried, and then demolded.

Metals, especially aluminum, as well as ceramics or glass are traditionally used to make such formers. However, metals have the disadvantages of being easily oxidized, not resistant to corrosive components such as acids, poor wear resistance, and short service life. Ceramics and glass, on the other hand, are brittle and cannot resist thermal and mechanical shock, which can be dangerous to operators when they break. In addition, the heavy weight of metal, ceramic or glass formers means that high energy consumption is required in the manufacture of moldings.

The dipping formers are required to have low weight and a long service life to provide cost-effectiveness.

There were some trials from glove former companies and plastic suppliers trying to solve above issues and to provide processes to offer plastic solutions comparable with metal, ceramic or glass in appearance but light weight.

For example, CN107053564A discloses a manufacturing method of a plastic glove former, which includes injection molding an upper casing and a lower casing of the glove former respectively, and then welding them into a complete glove former. Furthermore, CN 206066990U discloses a glove dipping former, which is made of glass fiber reinforced polyamide 4T and formed by welding different sections or halves together. Both of the formers are not one-piece and need to be welded to form a whole. This adds cost and is prone to damage during use.

WO2020260456A1 describes a glove former for latex dipping, which is one-piece on the surface and formed by injection or blow molding process. In WO2020260456A1, the former comprises a core-shell structure, and it is necessary to make the two parts via separate molding process. The glove former is produced by a process including injection molding or blow molding a first material into the first cavity to make the core; transferring the molded core into the second cavity; and injection molding a second material into the second cavity to overmold the molded core. The complex design causes challenges in molding process, for example, difficulty in retracting the core part. However, there is no solution mentioned.

CN108099067A discloses a method for integrally forming a plastic glove former. The method comprises molding the glove former in an injection molding machine coupled with a nitrogen production facility. However, it does not describe the technical design regarding fluid inlet and overflow cavity. Moreover, only fluoroplastic is used to mold the glove former.

Alternative solutions with plastic were tried to replace ceramic for former from the above prior arts, which brings some technical challenges such as
a). Complicated geometry of former, including undercut, which increases the difficulties of demolding when using injection molding;
b). Two-step manufacturing methods increase the overall manufacturing cost, and deteriorate the reproducibility, such as unstable welding performance;
c). One-step manufacturing method, such as liquid aided molding, cannot achieve nice surface and uniform part thickness;
d). Standard plastics cannot fulfill the need of long-term chemical resistance during cleaning and washing stage.

### SUMMARY DESCRIPTION

The object of the present invention is to overcome at least one of above-mentioned problems of the prior art, and to provide a method for producing a hollow molded part and an one-piece hollow molded part, which part has smooth and even surface appearance, but light weight compared with metal or ceramic molded part, and can survive a long term under high temperature, mechanical operation and chemical exposure.

The object has been achieved by a method for producing a hollow molded part, comprising producing the hollow molded part by fluid assistance injection molding.

The object has also been achieved by a hollow molded part, which is one-piece and has a main conduit at one end and a plurality of branches at the other end, wherein the molded part is made from a semi-aromatic polyamide resin composition.

The molded part is one-piece. In the context of the present invention, the term “one-piece” means that the molded part itself is integrally formed, without joining such as welding, fusing or assembling different parts during its production.

The term “distance” is the vertical dimension from one point to one plane.

### DESCRIPTION OF DRAWINGS

FIG. 1 shows the schematic diagram of the method of the present invention;

FIG. 2 shows an embodiment of the molded part of the invention; and

FIG. 3 shows the molded part of the example 3 with the individual dimensions.

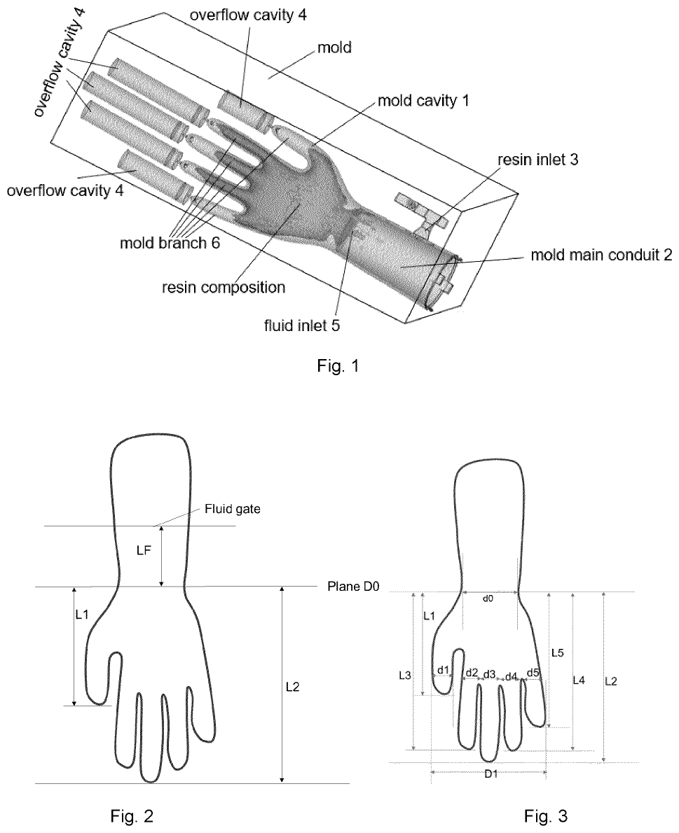

### DETAILED DESCRIPTION

### Method for Producing a Molded Part

In one aspect, the invention relates to a method for producing a hollow molded part, comprising producing the molded part by fluid assistance injection molding (FAIM), the method comprising the steps:
(1) molten resin composition is injected into a mold having a mold cavity 1 and at least one overflow cavity 4, wherein the mold cavity 1 includes a mold main conduit 2 and a plurality of mold branches 6 which are connected with the mold main conduit 2, the resin composition is a semi-aromatic polyamide resin composition, the mold main conduit 2 has an inflection point (i) at which variation trend of the major axes changes, the major axis is the longer axis of each cross section of the mold main conduit 2 along its length direction or (ii) the joint point of the mold main conduit 2 and the closest mold branch 6 if the major axes have the same length,
(2) fluid is injected into the molten resin composition via a fluid inlet 5 to obtain the molded part, the fluid inlet 5 is located inside the mold main conduit 2, and the distance LF, which is from the fluid inlet 5 to a plane D0, is not less than ½ of the distance L2, which is from the plane D0 to the end of the longest mold branch 6, the plane D0 is the one which the inflection joint is located in and is perpendicular to the length direction of the mold main conduit 2,
(3) demold the molded part,
   wherein the molded part is one-piece and has a main conduit at one end and a plurality of branches at the other end, the branches are connected with the main conduit, wherein the molded part is made from a semi-aromatic polyamide resin composition.

The mold main conduit 2 may have a major axis which is constant in the direction of the length, or have variable major axis in the direction of the length, for example, a plurality of different major axes from the opening of the mold main conduit 2 to the positions where the mold branches lie. Preferably, the mold main conduit 2 has variable major axes in the direction of the length.

If the major axes of the cross sections of the mold main conduit 2 are in different lengths, the inflection point means a point at which variation trend of the major axes of each cross section of the mold main conduit 2 along its length direction changes. For example, before the inflection point, the major axes of the mold main conduit 2 change from large to small, while after the point, the major axes of the mold main conduit 2 changes from small to large, as viewed from the opening. The “before” and “after” are used only to present the relative location, not used to define the detailed location. The major axis corresponds to the diameter if the cross section of the mold main conduit 2 is circle.

If the major axes of the cross sections of the mold main conduit 2 are in the same length, the inflection point means a joint point of the mold main conduit 2 and the closest mold branch 6.

The plane D0 is a pre-set plane which the inflection point is located in and is perpendicular to the length direction of the mold main conduit 2. In case more than one inflection points exist in the length direction of the mold main conduit 2, the planes that fulfil the requirement of plane DO can all be the plane D0. The plane comprising the inflection point farthest away from the mold branches 6 is the preferable plane D0.

In the conventional FAIM, it is difficult to fill the individual mold branches with the resin composition completely and to make the wall thickness uniform. However, in the present invention, it has surprisingly been found that when a suitable location of the fluid inlet 5 is chosen, it is possible to fill the individual mold branches with the resin composition and to obtain a molded part with a uniform wall thickness and length.

Specifically, the fluid inlet 5 is located inside the mold main conduit 2 (the mold main conduit 2 corresponds to the main conduit of the molded part), and the distance LF which is from the location of the fluid inlet 5 to the plane D0 is not less than ½ of the distance L2, which is from the plane D0 to the end of the longest mold branch 6 (which corresponds to the tip of the middle finger when the molded part of the invention is a glove former), that is, LF≥½ L2.

In one preferred embodiment, distance LF is not higher than 5 times of L2, preferably not higher than 3 times of L2.

The molded part may have 2 to 100, preferably 2-50, more preferably 2-20, most preferably 3-6 branches. The branches may have same or different lengths, preferably different lengths.

The wall thickness of the molded part can be adjusted as required, and for example, may be 2-8 mm, preferably 2-5 mm, more preferably 3-4 mm.

The main conduit of the hollow molded part has an opening at the end away from the joints with the branches. The diameter of the opening may be same as the end of the main conduit or slightly smaller.

In the FAIM of the present invention, a mold which has a mold cavity 1 in a shape corresponding to the hollow molded part to be is used. Particularly, the mold cavity 1 includes a mold main conduit 2 corresponding to the main conduit of the molded part and mold branches 6 corresponding to the branches of the molded part.

In the FAIM process, the molten semi-aromatic polyamide resin composition is injected into the mold cavity 1 via a resin inlet 3, and then fluid is injected into the resin composition via a fluid inlet 5 to push the resin composition to fill the entire mold cavity 1, and the resin composition is then gradually cooled. When the temperature of the molded part drops to the demolding temperature, the mold can be opened and the obtained molded part can be taken out. Compared with conventional injection molding, the FAIM of the present invention can improve the product surface quality, reduce warpage deformation, reduce clamping force, reduce product weight and save costs.

In the method of the present invention, the molten semi-aromatic polyamide resin composition is obtained by heating to a temperature above its melting temperature (Tm) and below its decomposition temperature, and then the molten semi-aromatic polyamide resin composition is injected into the mold by an injection molding machine via a resin inlet 3.

The amount of injected semi-aromatic polyamide resin composition can be adjusted as desired, and for example, may be 10-80%, preferably 20-70%, more preferably 30-60% of the capacity of the mold cavity 1. The mold temperature during Step (1) and (2) may be controlled in a range of 60-160° C., preferably 80-160° C., more preferably 120-160° C., most preferably 140-160° C.

The start time of the fluid injection can be determined as needed. The wall thickness of the product can be controlled by choosing the start time of the fluid injection. When a larger wall thickness is required, there may be large interval between an injection start time of the molten resin composition and the start time of fluid injection. Typically, the fluid injection begins at 0.5-15 seconds, preferably 0.5-10 s after the injection start time of the molten resin composition.

The fluid used may be an inert gas or liquid, such as air, nitrogen, steam or water. The fluid pressure and temperature can be selected as required. For example, if the fluid is in a form of gas, e.g., air, nitrogen or steam, the fluid pressure may be 0.1-5 MPa, preferably 1-4 MPa, and if the fluid is in a form of liquid, e.g., water, the fluid pressure may be 1-50 MPa, preferably 5-30 MPa.

The fluid temperature may be in a wide range, such as from −30° C. to 100° C. The injection of the fluid can be carried out by means of an injection unit, such as a gas needle or pump. The duration of the fluid injection can be adjusted, may be 0.1-30 seconds, preferably 0.5-20 seconds, more preferably 5-20 seconds.

The injected fluid pushes the molten resin composition to fill the entire mold cavity 1 until the molten resin composition fits on all the inner walls of the mold cavity 1.

Additionally, when there is too much molten resin composition in the mold cavity 1, the fluid can blow the excess resin composition out. In a preferred embodiment of the present method, there is an overflow cavity 4 at each end of the mold branches 6. Surprisingly, it was found that the presence of this overflow cavity 4 can improve the process reliability, resulting in a product with uniform wall thickness. There is not any particular limitation on the shape and size of the overflow cavity 4, and it generally may be cylindrical, the diameter of which is usually smaller than that of the branches.

In another embodiment of the present invention, the distance L2, which is from the plane DO to the end of the longest branch (that is, corresponding to the tip of the middle finger) is less than or equal to 10 times of the distance L1, which is from the plane D0 to the end of the shortest branch (that is, corresponding to the tip of the thumb), that is, L2/L1=1:1˜10:1, preferably, L2/L1=1:1˜3:1.

Furthermore, there is no particular limitation on the location of the resin inlet 3, which is usually located in the mold main conduit 2 and may locate before or behind the fluid inlet 5, preferably behind the fluid inlet.

After the fluid injection is completed, the fluid may be kept in the mold cavity 1 for 1-30 seconds. Then, the fluid is discharged from the mold and the molded part formed in the mold is allowed to cool, for example, for 5-360 seconds. After cooling, the molded part is demolded from the mold.

After demolding, the obtained molded part may be subjected to post-treatments such as trimming, surface cleaning, etc.

The semi-aromatic polyamide resin composition used in the present invention comprises at least one semi-aromatic polyamide resin comprising repeated units derived from aromatic dicarboxylic acids, diamines, and optionally other monomers such as amino acids and/or lactams. The aromatic dicarboxylic acid could have from 8 to 20 carbon atoms, more preferably from 8 to 14 carbon atoms, and can be terephthalic acid, naphthalenedicarboxylic acids, diphenyldicarboxylic acids, or the mixture of isophthalic acid and at least one selected from terephthalic acid, naphthalenedicarboxylic acids and diphenyldicarboxylic acids.

The semi-aromatic polyamide resin may also comprise repeated units derived from aliphatic diamines. The aliphatic diamine in the present invention could be linear or branched aliphatic diamines, preferably linear aliphatic diamines. The aliphatic diamine preferably comprises from 6 to 36, more preferably from 6 to 22 carbon atoms or 36 carbon atoms, most preferably from 6 to 12 carbon atoms. Examples of the linear aliphatic diamines are 1,6-hexane diamine, 1,8-octanediamine, 1,9-nonanediamine, 1,10-decanediamine, 1,11-undecanediamine, 1,12-dodecanediamine, 1,13-tridecanediamine, 1,14-tetradecanediamine, 1,16-hexadecanediamine, 1,18-octadecanediamine, 1,20-eicosanediamine and/or 1,22-docosanediamine, preferably are 1,6-hexane diamine, 1,8-octanediamine, 1,9-nonanediamine, 1,10-decanediamine, 1,11-undecanediamine and/or 1,12-dodecanediamine, more preferably are 1,9-nonanediamine, 1,10-decanediamine, 1,11-undecanediamine and/or 1,12-dodecanediamine. Examples of the branched aliphatic diamines are 2-methyl-1,5-pentane diamine, 3-methyl-1,5-pentane diamine, 2-methyl-1,8-octanediamine, 5-methyl-1,9-nonanediamine, 2,4,4-trimethylhexamethylene diamine, 2,2,4-trimethylhexamethylene diamine and/or 2,4-dimethyloctanediamine, preferably is 2-methyl-1,5-pentane diamine, 3-methyl-1,5-pentane diamine, 2-methyl-1,8-octanediamine, 2,4,4-trimethylhexamethylene diamine and/or 2,2,4-trimethylhexamethylene diamine.

The suitable amino acid in the present invention preferably comprises from 4 to 12 carbon atoms. Examples of the amino acid are 4-aminobutanoic acid, 6-aminocaproic acid, 7-aminoheptanoic acid, 8-aminooctanoic acid, 10-aminodecanoic acid, 11-aminoundecanoic acid and/or 12-aminododecanoic acid.

The suitable lactam in the present invention preferably comprises from 4 to 12 carbon atoms, more preferably from 6 to 12 carbon atoms. Examples of the lactam are 2-pyrrolidone (γ-butyrolactam), 2-piperidone (O-valerolactam), ε-caprolactam, capryllactam, decanelactam, un-decanolactam, enantholactam and/or lauryllactam, preferably is ε-caprolactam and/or undecan olactam.

In one preferred embodiment, the semi-aromatic polyamide resin comprises repeated units derived from the dicarboxylic acids comprising at least one aromatic dicarboxylic acid and the diamines comprising at least one aliphatic diamine. Preferably, the aliphatic diamine has carbon atoms from 8 to 14.

Preferably, the semi-aromatic polyamide resin is a polyphthalamide (PPA) resin, for example, PA 4T, 5T, 6T, PAST, PA9T, 10T or 12T, preferably PA 9T. Surprisingly, it was found that when PAST is used, the resulting molded part has good chemical resistance, low water absorption, good swelling resistance, and have good dimensional stability, making them ideal as glove formers.

The semi-aromatic polyamide resin in the present invention could also comprise a polyamide copolymer or a blend of two or more polyamides and copolyamides, for example PA 6T/6I, PA6T/66, PA 6T/8T, PA 6T/10T, PA 6T/10I, PA 10T/10I, PA 6T/9T, PA 6T/12T, PA 4T/6T/DT, PA 4T/10T/DT, PA 4T/4I/6T/6I/DT/DI, PA6T/12T/6I/12I PA 6T/10T/6I, PA 4T/6T/4I/6I, PA 5T/6T/5I/6I, PA 5T/4T/5I/4I, PA 4T/10T/5I/10I, PA 4T/6T/DT, PA 4T/10T/DT or PA4T/4I/6T/6I/DT/DI, preferably 6T/6I, PA 6T/10T, PA6T/12T, PA 6T/10T/6I, PA 6T/DT and/or PA 6T/DT/6I/DI. Herein D is 2-methyl-1,5-pentanediamine or 3-methyl-1,5-pentanedimine, or a mixture thereof.

The preferred amount of semi-aromatic polyamide resin is 50-100 wt %, preferably is 90-100 wt %, when no filler is used; and 50-95 wt %, preferably 60-90 wt %, more preferably 70-85 wt % when filler is used, based on the total amount of the semi-aromatic polyamide resin composition.

The semi-aromatic polyamide resin composition may comprise 0-50 wt % of fillers conventionally used in the art. There is no limitation to the form of filler, such as fiber, whisker, flake, or particles.

The fibers may be, for example, inorganic fibers, such as glass fibers, boron fibers, carbon fibers, silica fibers, ceramic fibers, wollastonite fiber, metal fibers, potassium titanate fiber, aluminum borate fibers and basalt fibers; organic reinforcing fibers, such as aramid fibers, polyester fibers, nylon fibers, polyethylene fibers; and natural fibers such as wood fibers, flax fibers, hemp fibers and sisal fibers. Glass fibers, carbon fibers and aramid fibers are preferred. The fibers may be chopped fibers, for example having a length of 2-500 mm, preferably 3-200 mm, and a diameter of 5-40 μm, preferably 10-25 μm. The fibrous fillers in the polyamide composition preferably have an average length of 2-500 μm, preferably 200-300 μm, more preferably 220-240 μm. The fibers may be present in an amount of 5-50 wt %, preferably 10-45 wt %, more preferably 15-35 wt %, based on the total weight of the composition. The fibers can be introduced by directly blending chopped fibers with the semi-aromatic polyamide resin, followed by extrusion; or by using long fiber strands to pultrude with the semi-aromatic polyamide resin, followed by chopping. The fibers may also be surface treated fibers, e.g., treated with a silane coupling agent.

Alternatively, the filler is used in the form of particles. The particulate fillers may have a variety of particle sizes, ranging from particles in dust form to coarse particles. The particles used may include organic or inorganic particles. Examples of materials that can be used are inorganic particles such as kaolin, chalk, wollastonite, talc, calcium carbonate, silicates, titanium dioxide, zinc oxide, graphite, mica, vermiculite, montmorillonite, glass particles (e.g., glass beads). The particles may also be a surface-treated filler. The particles content may be 5-50 wt %, preferably 10-45 wt %, more preferably 15-35 wt %, based on the total weight of the composition.

Besides the filler, the semi-aromatic polyamide resin composition may optionally comprise other additives conventionally used in the art, such as lubricants, heat stabilizers, flame retardants, light stabilizers (UV stabilizers, UV absorbers or UV blockers), nucleating agents, pigments and dyes, antistatic agents, fluorescent whitening agents, surface modifiers, flow modifiers etc.

The additives may be used in a total amount of 0-10 wt %, preferably 0-5 wt %, more preferably 0-2 wt %, based on the total weight of the composition.

The lubricant includes any one or a combination of at least two of stearate, titanate, stearic acid, erucamide, oleamide or silicone. Very particularly preferred lubricants are calcium stearate, calcium montanate or aluminium stearate.

The thermal stabilizer is preferably selected from copper compounds, secondary aromatic amines, sterically hindered phenols, phosphites, phosphonites and mixtures thereof.

Examples of suitable copper compounds are salts of monovalent or divalent copper with inorganic or organic acids or with mono- or difunctional phenols, monovalent or divalent copper oxides and complexes with ammonia, with amines, with amides, with lactams, with cyanides or phosphines, preferably Cu(I) or Cu(II) salts of hydrohalic acid or hydrocyanic acid, or copper salts of aliphatic carboxylic acids. The monovalent copper compound is particularly preferably CuCl, CuBr, CuI, CuCN and Cu₂O, and the divalent copper compound is particularly preferably CuCl₂, CuSO₄, CuO, copper (II) acetate or copper (II) stearate.

Examples of secondary aromatic amine stabilizers are the adduct of phenylenediamine with acetone (Naugard® A), the adduct of phenylenediamine with linolenic acid, or 4,4′-bis(α,α-dimethyl benzyl)diphenylamine (Naugard® 445), N,N′-dinaphthyl-p-phenylenediamine, N-phenyl-N′-cyclohexyl-p-phenylenediamine, or the mixture of two or more thereof.

Preferred examples of sterically hindered phenol stabilizers are N,N′-hexamethylene bis-3-(3,5-di-tert-butyl-4-hydroxyphenyl) propionamide, bis-(3,3-bis-(4′-hydroxy-3′-tert-butylphenyl) butyrate), 2,1′-thioethylbis(3-(3,5-di-tert-butyl-4-hydroxyphenyl) propionate, 4,4′-butenyl bis(3-methyl-6-tert-butylphenol), triethylene glycol 3-(3-tert-butyl-4-hydroxy-5-methylphenyl) propionate, and mixtures of two or more of these stabilizers.

Examples of phosphites and phosphonites are triphenyl phosphite, diphenyl alkyl phosphite, phenyl dialkyl phosphite, tris(nonylphenyl) phosphite, trilauryl phosphite, tris-tridecyl phosphite, distearyl pentaerythritol diphosphite, tris(2,4-di-tert-butylphenyl) phosphite, diisodecyl pentaerythritol diphosphite, bis(2,4-di-tert-butylphenyl) pentaerythritol diphosphite, bis(2,6-di-tert-butyl-4-methylphenyl) pentaerythritol diphosphite, diisodecyloxy pentaerythritol diphosphite, bis(2,4-di-tert-butyl 6-methylphenyl) pentaerythritol diphosphite, bis(2,4,6-tri (tert-butylphenyl)) pentaerythritol diphosphite, tristearoyl sorbitol triphosphite, tetrakis (2,4 di-tert-butylphenyl) 4,4′-biphenylene diphosphonite, 6-isooctyloxy-2,4,8,10-tetra-tert-butyl-12H-dibenzo[d,g]-1,3,2-dioxaphosphacyclooctadiene, 6-fluoro-2,4,8,10-tetra-tert-butyl-12-methyldibenzo[d,g]-1,3,2 dioxaphosphacyclooctadiene, bis(2,4-di-tert-butyl-6-methylphenyl)methylphosphite, bis(2,4-di-tert-butyl-6-methylphenyl)ethyl phosphate and tris[2-tert-butyl-4-thio(2′-methyl-4′-hydroxy-5′-tert-butyl)-phenyl-5-methyl]phenylphosphite.

Examples of flame retardants are halogen-containing and halogen-free flame retardants and their synergists. Preferred halogen-free flame retardants are red phosphorus, phosphinates or bisphosphinates and/or nitrogen-containing flame retardants such as melamine, melamine cyanurate, melamine sulfate, melamine borate, melamine oxalate, melamine phosphate, trihydroxyethyl isocyanurate.

Examples of light stabilizers are resorcinols, salicylates, benzotriazoles and benzophenones, as well as sterically hindered P-containing compounds, sterically hindered amines and carbodiimines.

The nucleating agent used may be sodium phenylphosphonite, alumina, silica, or talc, preferably talc.

The pigments used may be inorganic pigments, such as titanium dioxide, ultramarine blue, iron oxides, ZnO and boehmite, AIO (OH), etc.; organic pigments, such as phthalocyanines, quinacridones or perylenes, etc. Dyes are all dyes which can be used for transparent, translucent or non-transparent coloring, especially those suitable for coloring polyamides. Among them, those suitable for transparent and translucent coloring are preferred. Such dyes are known to those skilled in the art.

The preparation of the semi-aromatic polyamide resin composition is achieved by methods known per se. This comprises mixing the components in appropriate weight ratios. The components are preferably mixed at elevated temperature by combining, mixing, kneading, extrusion or rolling. The mixing temperature is preferably 300 to 350° C., especially 310 to 340° C., especially 320 to 340° C. Suitable methods are known to those skilled in the art.

In a preferred embodiment, the semi-aromatic polyamide resin composition comprises:
i) 50-95 wt %, preferably 60-90 wt %, more preferably 70-85 wt % of semi-aromatic polyamide resin, preferably PPA;
ii) 5-50 wt %, preferably 10-45 wt %, more preferably 15-35 wt % of fillers, and
iii) optionally, an additive, preferably, a heat stabilizer.

In a more preferred embodiment, the semi-aromatic polyamide resin composition comprises:
i) 50-95 wt %, preferably 60-90 wt %, more preferably 70-85 wt % of PA9T;
ii) 5-50 wt %, preferably 10-45 wt %, more preferably 15-35 wt % of glass fibers, and
iii) optionally, an additive, preferably, a heat stabilizer.

### Molded Part of the Invention

In another aspect, the present invention relates to a hollow molded part, which is one-piece and has a main conduit at one end and a plurality of branches at the other end, the branches are connected with the main conduit, wherein the molded part is made from a semi-aromatic polyamide resin composition.

The dimensions of the main conduit and branches are as described above for the method for producing a molded part. In addition, there are also inflection points in the main conduit of the mold.

The hollow molded part may have 2 to 100, preferably 2-50, more preferably 2-20, most preferably 3-6 branches, e.g., 2 branches, 3 branches, 4 branches, 5 branches, 6 branches. The branches may have same or different lengths, preferably different lengths.

The wall thickness of the molded part can be adjusted as required, and for example, may be 2-8 mm, preferably 2-5 mm, more preferably 3-4 mm.

The main conduit of the hollow molded part has an opening at the end away from the branches. The major axis of the opening may be same as the end of the main conduit or slightly smaller.

The main conduit may have a major axis which is constant in the direction of the length, or have variable major axes in the direction of the length, for example, a plurality of different major axes from the opening of the main conduit to the positions where the branches lie. Preferably, the main conduit has variable major axes in the direction of the length.

The molded part may have an inflection point (i) at which variation trend of the major axes changes, the major axis is the longer axis of each cross section of the main conduit along its length direction or (ii) the joint point of the main conduit and the closest branch if the major axes have the same length.

If the major axes of the cross sections of the main conduit are in different lengths, the inflection point means a point at which variation trend of the major axes of each cross section of the main conduit along its length direction changes. For example, before the inflection point, the major axes of the main conduit change from large to small, while after the point, the major axes of the main conduit changes from small to large, as viewed from the opening. The “before” and “after” are used only to present the relative location, not used to define the detailed location. The major axis corresponds to the diameter if the cross section of the main conduit is circle.

If the major axes of the cross sections of the main conduit are in the same length, the inflection point means a joint point of the main conduit and the closest branch.

Herein, the inflection point refers to the portion in the molded part corresponding to that of the mold.

In one embodiment of the present invention, the molded part is a glove former. In this case, the hollow molded part has a shape of glove. Particularly, the molded part has a shape of glove, including a sleeve-shaped region, a palm-shaped region, and a finger-shaped region. The mold main conduit 2 is used to form the sleeve-shaped region and the palm-shaped region of the glove, while the mold branches 6 are used to form the finger-shaped region, and the number of branches is 5. The glove former usually has branches. The mold main 2 conduit may have lengths and dimensional size corresponding to the sleeve-shaped region and palm-shaped region of the glove to be produced; the plurality of branches may have different lengths and diameters corresponding to the finger-shaped region.

In one more preferred embodiment, for a glove former, the distance L2, which is from the plane D0 to the end of the longest branch (that is, corresponding to the tip of the middle finger) is less than or equal to 10 times of the distance L1, which is from the plane D0 to the end of the shortest branch (that is, corresponding to the tip of the thumb), that is, L2/L1=1:1˜10:1, preferably, L2/L1=1:1˜3:1. The plane D0 is the one which the inflection joint is located in and is perpendicular to the length direction of the mold main conduit 2,

In one more preferred embodiment, for a glove former, the thickness of the glover former is 2-5 mm, preferably 3-4 mm.

The semi-aromatic polyamide resin compositions used are those described above for the method for producing a molded part.

### Use of the Molded Part According to the Invention

In another aspect, the present invention relates to use of the molded part of the invention or the molded part obtainable by the method of the invention as a dipping former, preferably a glove former.

A dipping former is a structural member which could model a shape of an object and enable the formation of a dip-molding corresponding to the shape of the object. The dip-molding can be made by a so-called dipping process. In such a process, the dipping former is dipped or immersed into a polymer emulsion, suitably being a rubber latex or a vinyl polymer emulsion, and polymer particles in the emulsion, more particularly rubber particles in the latex, coalesce and produce a coherent polymer film on the dipping former. The film will be in the shape of the dipping former. In its simplest form, dipping is a process in which thin-walled polymer (usually rubber) products are produced by first immersing a former in a polymer emulsion or rubber latex which has been suitably compounded, and subsequently slowly withdrawing the former from the emulsion or latex in such a way as to leave a uniform deposit upon the former. The thickness of the deposit can be increased if desired by repetition of the dipping and coalescence step. The formation of the product is completed by leaching, drying and, if necessary, subjecting it to appropriate treatments, of which the most obvious is vulcanization of the rubber. The product may also be subjected to appropriate post-treatments. In many cases, it is the practice to form a rolled bead at the open end(s) of the moldings. The purpose of the bead is principally to reinforce the thin film against tear-initiation from the edge of the open end. It also prevents very thin-walled moldings from adopting various distorted configurations. The product is usually removed from the former before use.

When the molded part of the present invention is used as a dipping former, preferably a glove former, it has a surface quality comparable to that of a conventional metal, ceramic or glass former, but lightweight, and can survive during glove production process involving high temperature, mechanical operation and chemical exposure. Therefore, the molded part of the present invention, when used as a dipping former, has a long service life, usually above 2 years, which is much longer than conventional ceramic molds (usually 0.5-1 year).

### Example

The present invention is further illustrated by the following examples, but the present invention is not limited thereto.

### General Procedure

The semi-aromatic polyamide resin composition is Ultramid Advanced N3HG6 LS BK from BASF, which is made from PA9T and 30% glass fiber and heat stabilizer.

The pelletized PAST composition was injection molded in an airmould® ^{next} fluid-assisted injection machine at 330° C. The mold is used to form a glove former, and the mold temperature is 140° C. The semi-aromatic polyamide resin composition melt was injected for 3.5 seconds. Nitrogen injection was started 3.0 seconds after the injection start of the resin composition. The nitrogen temperature is 23° C., and the pressure is 1.8 MPa. The duration of nitrogen injection is 15 seconds. After the nitrogen injection was completed, the pressure in the mold cavity was kept constant for 10 seconds, and then the nitrogen was vented. After the mold has cooled down for 100 seconds, the mold is demolded and the molded part is removed. In the procedure, the resin inlet is located at the rear of the fluid inlet and 3 cm away from the fluid inlet.

The mold used is shown in FIG. 2, wherein the parameters are shown in the following:

| | | | |
|---|---|---|---|
| L1: | 135 mm | L2: | 213 mm |
| L3: | 202 mm | L4: | 207 mm |
| L5: | 182 mm | d1: | 22 mm |
| d2: | 20 mm | d3: | 20 mm |
| d4: | 20 mm | d5: | 20 mm |

The molded part of example 3 is shown in FIG. 3, wherein the parameters are shown in the following:

| | | | |
|---|---|---|---|
| L1: | 130 mm | L2: | 208 mm |
| L3: | 197 mm | L4: | 202 mm |
| L5: | 177 mm | d1: | 17.8 mm |
| d2: | 14.6 mm | d3: | 16.5 mm |
| d4: | 15.5 mm | d5: | 13.0 mm |
| d0: | 58.5 mm | D1: | 114 mm |

The thickness of the molded part is in a range of 2-4 mm.

### Comparative Example 1

The molded part is produced according to the above general procedure, wherein the fluid inlet is located ⅕ of the distance L2 away from the plane D0, i.e., LF=42 mm. L1 of the first branch (corresponds to thumb) is 60 mm, L5 of the fifth branch (corresponds to little finger) is 80 mm, which are only about half of the L1 and L5 of the molded part produced in Example 3. L3 of the second branch (corresponds to forefinger) is 147 mm, L4 of the fourth branch (corresponds to ring finger) is 181 mm. L2 (corresponds to middle finger) is 206 mm.

### Comparative Example 2

Repeating Comparative Example 1, except that the fluid inlet is located ⅓ of the distance L2 away from the plane D0, i.e., LF=71 mm. L1 of the first branch (corresponds to thumb) is 97 mm, L5 of the fifth branch (corresponds to little finger) is 131 mm, which are only about ¾ of the L1 and L5 of the molded part produced in Example 3. L3 of the second branch (corresponds to forefinger) is 177 mm, L4 of the fourth branch (corresponds to ring finger) is 151 mm. L2 (corresponds to middle finger) is 207 mm.

### Example 3

Repeating Comparative Example 1, except that the fluid inlet is located ½ of the distance L2 away from the plane D0, i.e., LF=105 mm.

### Result Evaluation

The surface of the molded parts obtained from Comparative Examples 1 and 2 as well as Example 3 were evaluated.

The surfaces of molded parts obtained from Comparative Examples 1 and 2 as well as Example 3 are smooth, and there was no defect such as crack, bubble and hole, and no glass fiber rich on the surface. Each of the branches of the molded part obtained from Example 3 are filled completely, and the wall thickness is uniform. However, the molded part obtained from Comparative Examples 1 and 2 are not filled completely, and the wall thickness is not uniform.

The glove former of Example 3 was used in the factory to manufacture nitrile rubber gloves and found to have a service life of above 2 years.

The molded part produced from Example 3 has the alkali corrosion rate in 10 wt % NaOH solution is 0.012%, and the acid corrosion rate in 10 wt % HNO₃ solution is 0.018%. They were tested by dipping the molded part in acid or alkali solution in room temperature, check the weight change after 48 hrs.

1.-17. (canceled)

18. A method for producing a hollow molded part, comprising producing the hollow molded part by fluid assistance injection molding, the method comprising the steps:
Step (1): molten resin composition is injected into a mold having a mold cavity (1) and at least one overflow cavity (4), wherein the mold cavity (1) includes a mold main conduit (2) and a plurality of mold branches (6) which are connected with the mold main conduit (2), the resin composition is a semi-aromatic polyamide resin composition, the mold main conduit (2) has an inflection point (i) at which variation trend of the major axes changes, the major axis is the longer axis of each cross section of the mold main conduit (2) along its length direction or (ii) the joint point of the mold main conduit (2) and the closest mold branch (6) if the major axes have the same length,
Step (2): fluid is injected into the molten resin composition via a fluid inlet (5) to obtain the molded part, the fluid inlet (5) is located inside the mold main conduit (2), and the distance LF, which is from the fluid inlet (5) to a plane D0, is not less than ½ of the distance L2, which is from the plane D0 to the end of the longest mold branch (6), the plane D0 is the one which the inflection joint is located in and is perpendicular to the length direction of the mold main conduit (2), and
Step (3): demold the molded part,
wherein the molded part is one-piece and has a main conduit at one end and a plurality of branches at the other end, the branches are connected with the main conduit, wherein the molded part is made from a semi-aromatic polyamide resin composition.

19. The method for producing a hollow molded part according to claim 18, wherein the distance LF is not higher than 5 times of L2.

20. The method for producing a hollow molded part according to claim 18, wherein the fluid injection begins at 0.5-15 seconds after the injection start time of the molten resin composition.

21. The method for producing a hollow molded part according to claim 18, wherein the duration of the fluid injection is 0.1-30 seconds.

22. The method for producing a hollow molded part according to claim 18, wherein if the fluid is in a form of gas, the fluid pressure is 0.1-5 MPa, and if the fluid is in a form of liquid, the fluid pressure is 1-50 MPa; and the fluid temperature is from −30° C. to 100° C.

23. The method for producing a hollow molded part according to claim 18, wherein there is one overflow cavity (4) at each end of the mold branches (6) of the mold.

24. The method for producing a hollow molded part according to claim 18, wherein the ratio of distance L2 which is from the plane D0 to the end of the longest branch to distance L1 which is from the plane D0 to the end of the shortest branch is in a range of 1:1˜10:1.

25. The method for producing a hollow molded part according to claim 18, wherein the mold temperature during Step (1) and (2) is controlled in a range of 60-160° C.

26. The method for producing a hollow molded part according to claim 18, wherein the semi-aromatic polyamide resin composition comprises at least one semi-aromatic polyamide resin comprising repeated units derived from aromatic dicarboxylic acids, diamines, and optionally other monomers such as amino acids and/or lactams.

27. The method for producing a hollow molded part according to claim 18, wherein the aromatic dicarboxylic acid is selected from the group of terephthalic acid, naphthalenedicarboxylic acids, diphenyldicarboxylic acids, or the mixture of at least one selected from terephthalic acid, naphthalenedicarboxylic acids and diphenyldicarboxylic acids, and isophthalic acid.

28. The method for producing a hollow molded part according to claim 18, wherein the semi-aromatic polyamide resin is present in an amount of 50-100 wt %, when no filler is used; and the semi-aromatic polyamide resin is present in an amount of 50-95 wt %, when filler is used, in each case based on the total amount of the semi-aromatic polyamide resin composition.

29. A hollow molded part, wherein it is one-piece and has a main conduit at one end and a plurality of branches at the other end, the branches are connected with the main conduit, the molded part is made from a semi-aromatic polyamide resin composition.

30. A hollow molded part, wherein it is one-piece and has a main conduit at one end and a plurality of branches at the other end, the branches are connected with the main conduit, the molded part is made from a semi-aromatic polyamide resin composition, wherein the hollow molded part is produced from the method according to claim 18.

31. The hollow molded part according to claim 29, wherein the molded part has 2 to 100.

32. The hollow molded part according to claim 29, wherein the wall thickness of the molded part is 2-8 mm.

33. The hollow molded part according to claim 29, wherein the hollow molded part is a dipping former.

34. The hollow molded part according to claim 33, wherein the dipping former is a glove former.
